(19) United States
(12) Patent Application Publication
(10) Pub. No.: US 2026/0332458 A1
(43) Pub. Date: Oct. 22, 2026

(54) NONLINEAR EQUALIZERS HAVING STAGED ADAPTATION OF LINEAR AND NONLINEAR PARAMETER COMPONENTS

(71) Applicant: Credo Technology Group Limited, George Town (KY)

(72) Inventors: FANG CAI, SAN CARLOS, CA (US); JUNQING SUN, FREMONT, CA (US); HAOLI QIAN, FREMONT, CA (US)

(73) Assignee: Credo Technology Group Limited, George Town (KY)

(21) Appl. No.: 19/181,839

(22) Filed: Apr. 17, 2025

(51) Int. Cl. H04L 25/03

(52) U.S. Cl. CPC H04L 25/03057

(57) ABSTRACT

Receivers, equalizers, and associated methods are provided with staged adaptation of linear and nonlinear components of equalization parameters. One illustrative receiver includes: an equalizer that provides an equalized signal to one or more symbol decision elements each employing multiple decision thresholds to render symbol decisions; an equalization error calculator determining an equalization error signal by subtracting, from the equalized signal, target levels corresponding to the symbol decisions; and an adaptation module that uses the equalization error to adapt at least one of: a receive signal gain, a filter coefficient of the equalizer, and a sampling clock phase. The illustrative receiver further includes an envelope detector that measures an envelope of the equalized signal; and a controller that determines an equalization parameter adjustment based on the envelope and determines gain-adjusted target levels by applying the equalization parameter adjustment to the target levels in proportion to their associated symbols.

### BACKGROUND

Digital communications occur between sending and receiving devices over an intermediate communications medium, or “channel” (e.g., a fiber optic cable or insulated copper wires). Each sending device typically transmits symbols at a fixed symbol rate, while each receiving device detects a (potentially corrupted) sequence of symbols and attempts to reconstruct the transmitted data. A “symbol” is a state or significant condition of the channel that persists for a fixed period called a “symbol interval.” A symbol may be, for example, an electrical voltage or current level, an optical power level, a phase value, or a particular frequency or wavelength. A change from one channel state to another is called a symbol transition. Each symbol may represent (i.e., encode) one or more binary bits of the data. Alternatively, the data may be represented by symbol transitions, or by a sequence of two or more symbols.

Many digital communication links use only one bit per symbol; a binary ‘0’ is represented by one symbol (e.g., an electrical voltage or current signal within a first range), and binary ‘1’ by another symbol (e.g., an electrical voltage or current signal within a second range), but higher-order signal constellations are known and frequently used. In 4-level pulse amplitude modulation (PAM 4), each symbol interval may carry any one of four symbols, denoted as −3, −1, +1, and +3. Two binary bits can thus be represented by each symbol.

Channel non-idealities produce dispersion which may cause each symbol to perturb its neighboring symbols, a consequence known as inter-symbol interference (ISI). ISI can make it difficult for the receiving device to determine which symbols were sent in each interval, particularly when such ISI is combined with additive noise.

To combat noise and ISI, receiving devices may employ various equalization techniques. Linear equalizers generally must balance between reducing ISI and avoiding noise amplification. Decision Feedback Equalizers (DFE) are often preferred for their ability to combat ISI without inherently amplifying the noise. As the name suggests, a DFE employs a feedback path to remove ISI effects derived from previously decided symbols. Other potentially suitable equalization and demodulation techniques are available in the relevant academic literature, including, e.g., peak detectors and partial response equalization. Most such techniques employ some form of channel characterization or receiver adaptation to enhance performance and suitability for use in challenging conditions. While desirable, the implementations of such features must be achieved within strict complexity constraints (limitations on areal and power requirements). Though many such implementations exist, there remains significant room for improvement, particularly when dealing with channel nonlinearities such as those encountered in fiberoptic cables.

### SUMMARY

Accordingly, there is provided herein receivers, equalizers, and associated methods having staged adaptation of linear and nonlinear components of equalization parameters. One illustrative receiver includes: an equalizer that provides an equalized signal to one or more symbol decision elements each employing multiple decision thresholds to render symbol decisions; an equalization error calculator determining an equalization error signal by subtracting, from the equalized signal, target levels corresponding to the symbol decisions; and an adaptation module that uses the equalization error to adapt at least one of: a receive signal gain, a filter coefficient of the equalizer, and a sampling clock phase. The illustrative receiver further includes an envelope detector that measures an envelope of the equalized signal; and a controller that determines an equalization parameter adjustment based on the envelope and determines gain-adjusted target levels by applying the equalization parameter adjustment to the target levels in proportion to their associated symbols.

An illustrative receiving method includes: (1) providing an equalized signal to one or more symbol decision elements each employing multiple decision thresholds to render symbol decisions; (2) determining an equalization error signal by subtracting, from the equalized signal, target levels corresponding to the symbol decisions; (3) using the equalization error to adapt at least one of: a receive signal gain, a filter coefficient of the equalizer, and a sampling clock phase; (4) measuring an envelope of the equalized signal; (5) determining an equalization parameter adjustment based on the envelope; and (6) calculating gain-adjusted target levels by applying the equalization parameter adjustment to the target levels in proportion to their associated symbols.

Also disclosed is a semiconductor intellectual property core to generate receiver circuitry for implementing the above method. The core may reside on a nontransient information storage medium such as a magnetic disk drive, a solid-state disk drive, a nonvolatile semiconductor memory device, or even a volatile memory array configured to store the information indefinitely.

Each of the foregoing embodiments may be implemented individually or conjointly, together with any one or more of the following optional features in any suitable combination: 1. the target levels are determined independently to account for nonlinearities in the equalized signal. 2. the equalization parameter adjustment has a magnitude less than an amount corresponding to a least significant bit of each target level as represented within the equalization error calculator. 3. the controller represents each target level using a higher bit resolution than the equalization error calculator. 4. a level finder configurable to determine median signal levels for each symbol. 5. the controller uses the level finder to determine refined versions of the gain-adjusted target levels. 6. the level finder further operates as the envelope detector. 7. the equalizer is a decision feedback equalizer including: a precompensation unit using the one or more symbol decision elements to produce tentative symbol decisions, each symbol decision element using comparators configured to compare the equalized signal to the multiple decision thresholds, the multiple decision thresholds accounting for a channel response to a set of speculative symbols including a speculative current symbol and a speculative preceding symbol, the speculative preceding symbol being different for different decision elements; a register configured to track a preceding symbol decision of the decision feedback equalizer; and a multiplexer configured to supply a current symbol decision selected from the tentative symbol decisions to the register based on the preceding symbol decision. 8. the target levels used by the equalization error calculator include an independent target level for each combination of the current symbol decision and the preceding symbol decision. 9. after determining the refined versions, the controller determines adjustments to the refined versions of the target levels to anchor the target levels to the gain-adjusted target levels.

### BRIEF DESCRIPTION OF THE DRAWINGS

FIG. 1 is a plan view of a wafer patterned with integrated circuit devices.

FIG. 2 is a block diagram of an illustrative application-specific integrated circuit.

FIG. 3A is a perspective view of an illustrative fiberoptic cable connector.

FIG. 3B shows an illustrative fiberoptic cable.

FIG. 3C is a block diagram of an illustrative fiberoptic cable.

FIG. 4A shows an illustrative decision feedback equalizer (DFE) implementation.

FIG. 4B shows an illustrative DFE employing a one-tap precompensation unit.

FIG. 4C shows an illustrative DFE with a fully unrolled precompensation unit.

FIG. 4D shows an illustrative parallelized DFE.

FIG. 5 shows an illustrative eye diagram.

FIG. 6 shows an illustrative bathtub curve.

FIG. 7 is a flow diagram of an illustrative adaptive equalization method.

### DETAILED DESCRIPTION

While specific embodiment details are provided in the drawings and the following description, they do not limit the disclosure. On the contrary, these details provide the foundation for one of ordinary skill to discern the alternative forms, equivalents, and modifications that are encompassed in the scope of the appended claims.

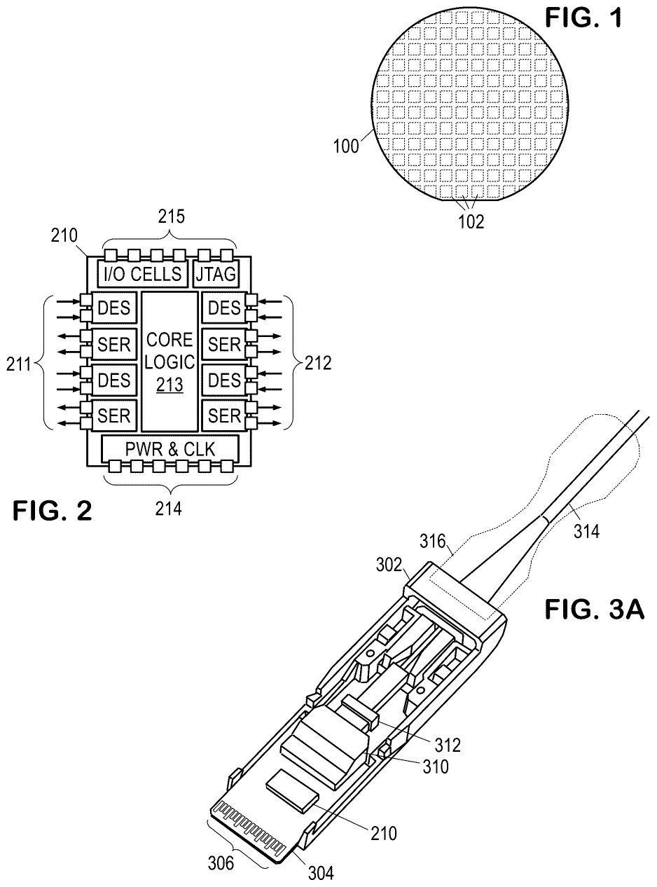

FIG. 1 shows a plan view of a semiconductor wafer 100, patterned to form an array of integrated circuits 102 which can be diced apart into IC chips and packaged as modular components for assembly into electronic devices. The IC chips can be packaged individually or combined into multi-chip modules using an interposer and/or package substrate, in either case employing a ball grid array or wire lead frame to provide external contacts for electrically connecting to other circuit components, usually via a printed circuit board. Each IC chip can implement digital logic, analog functionality, and/or mixed signal circuitry.

The patterning of wafers is performed by a semiconductor fabrication plant (“fab”) applying a series of cleaning, alignment, deposition, patterning, etching, implantation, and related processes. The “recipe” (the sequence of patterns and process steps) employed determines the functionality of the resulting integrated circuits. Electronic device designers working for the fab's customers, or for the company that owns the fab, specify the recipe to be used. The designers facilitate the design process by relying on modular layout design units to implement desired elements of the integrated circuit, arranging and joining them as needed to implement the various functions of the desired device. These modular units may be predefined units obtained from an existing library or from vendors that specialize in designing the desired type of element. Each modular unit has a defined interface and behavior that has been verified by its creator. Though each modular unit may take significant time and investment to create, its availability for reuse and further development cuts product cycle times dramatically and enables better products. The predefined units can be organized hierarchically, with a given unit incorporating one or more lower-level units and in turn being incorporated within higher-level units. The predefined modular units are also known as cells, blocks, cores, and macros, terms which have different connotations and variations (“intellectual property (IP) core”, “soft macro”) but are frequently employed interchangeably.

The modular units can be expressed in different ways, e.g., in the form of a hardware description language (HDL) file, or as a fully routed design that could be directly printed to create a series of manufacturing process masks. Fully routed design files are typically process-specific, meaning that additional design effort would usually be needed to migrate the modular unit to a different process or manufacturer. Modular units in HDL form require subsequent synthesis, placement, and routing steps for implementation, but are process-independent, meaning that different manufacturers can apply their preferred automated synthesis, placement, and routing processes to implement the units using a wide range of manufacturing processes. By virtue of their higher-level representation, HDL units may be more amenable to modification and the use of variable design parameters, whereas fully routed units may offer better predictability in terms of areal requirements, reliability, and performance.

While there is no fixed rule, digital module designs are more commonly specified in HDL form, while analog and mixed-signal units are more commonly specified as a lower-level, physical description. In any case, such semiconductor IP cores may be kept in a design database which resides on a nontransient information storage medium, e.g., a hard disk, flash drive, or any of the known hardware implementations for cloud-based abstractions of nonvolatile information storage. Once the device has been fully designed, commercially available software may convert the semiconductor intellectual property cores and other integrated circuit components into semiconductor mask patterns also stored on a nontransient information storage medium. Thereafter, the patterns may be conveyed to the various process units in a suitable assembly line of an integrated circuit manufactory to form and package the IC chips.

FIG. 2 shows an illustrative high-speed serializer/deserializer (“SerDes”) retimer chip 210, which serves here as an example of an integrated circuit device that can be made in the described fashion. Chip 210 includes SerDes modules with contacts 211 for receiving and transmitting high-rate serial bitstreams across four lanes in one direction, additional SerDes modules with contacts 212 for receiving and transmitting the high-rate serial bitstreams across four lanes in another direction, and core logic 213 for implementing a channel communications protocol while buffering bitstreams between the two directions. Though four lanes are shown here, the actual number can be larger or smaller as needed.

Also included are various supporting modules and contacts 214, 215, such as power regulation and distribution, clock generation, digital input/output lines for control, and a JTAG module for built-in self testing. The chip designer can design the device by placing the predefined modular units for the serializers, deserializers, power, clock generator, I/O cells, and JTAG; and routing the interconnections between the modular units with a bit of supporting logic.

The receiver, or “deserializer”, implements the receiving function of the chip 210, implementing any suitable equalization technique, e.g., peak detection, linear equalization, partial response equalization, and decision feedback equalization (DFE). In many cases, DFE is preferred and will be used here to provide context for explaining operation of the staged adaptation process disclosed herein. Regardless, the reader will recognize the suitability of the process for use with other equalizers or, more generally, for use with other receivers of wired or wireless digital signals.

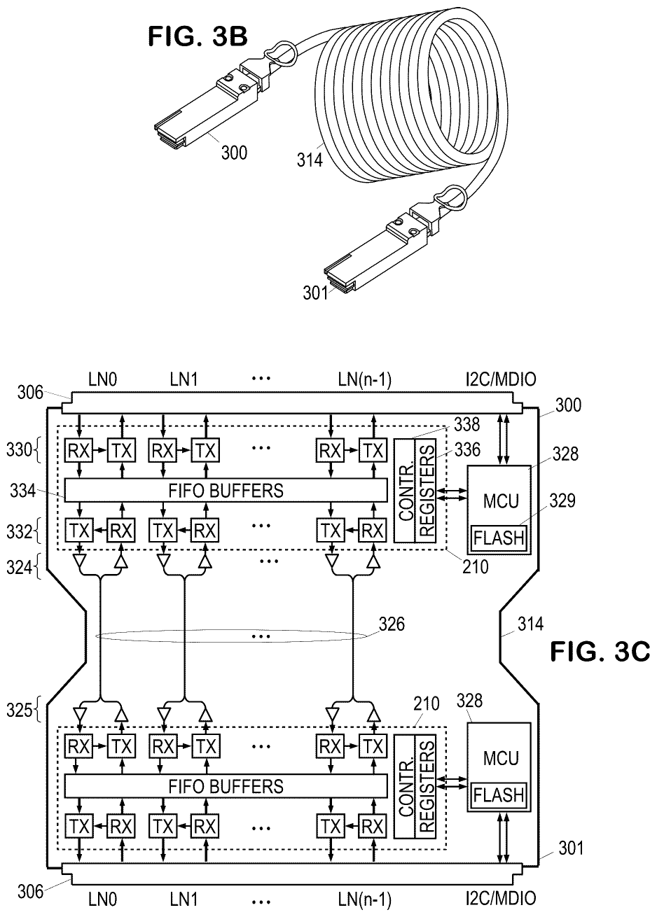

The packaged chip 210 may be incorporated into, e.g., the network port of an electronic system, into an optical module, or into a cable connector such as that shown in FIG. 3A. A connector frame 302 houses a printed circuit board (PCB) assembly 304 configured with edge connector contacts 306 that mate with contacts in a socket of a host device's network interface port to send and receive electrical signals. The PCB assembly 304 includes one or more packaged integrated circuit (IC) chips or discrete electrical components mounted to contact pads on the PCB. For example, the PCB assembly 304 may include a retimer chip 210 to equalize received signals, recover the data, and retransmit the recovered data, optionally providing error correction, signal format conversion, and lane deskew.

The PCB assembly 304 includes an optical coupling module 310 that couples integrated photodetectors and photoemitters to one or more optical paths. When mated with the optical coupling module 310, a ferrule 312 aligns one or more optical fibers of the fiberoptic cable 314 with the one or more optical paths. The optical coupling module 310 may typically use lenses and prisms to define the optical paths that couple light signals between the optical fibers and the photodetectors and photoemitters, though other optical elements (e.g., mirrors, gratings) would also be suitable. The fiberoptic cable connector may further include a cover and a finger grip 316 to protect the other components from damage during normal use.

FIG. 3B shows a perspective view of an illustrative cable 314 that may include the end connectors of FIG. 3A. Such cables may be used to provide a high-bandwidth communications link between devices in a routing network such as that used for data centers, server farms, and interconnection exchanges. The routing network may be part of, or may include, for example, the Internet, a wide area network, or a local area network. The linked devices may be computers, switches, routers, and the like. The cable includes a first connector 300 and a second connector 301 that are connected via optical fibers in the cord 314. Each connector 300, 301, includes a retimer chip 210, also known as a data recovery and re-modulation (“DRR”) device, that performs clock and data recovery of incoming data streams, which are then remodulated and retransmitted as outgoing data streams. The DRR devices each process data streams traveling in each direction, optionally converting between non-return to zero (“NRZ”) and 4-level pulse amplitude modulation (“PAM4”) or between other different signaling formats (including electrical-to-optical and vice versa).

FIG. 3C is a function-block diagram of the illustrative cable of FIG. 3B. Connector 300 includes edge connector terminals 306 adapted to fit a standard-compliant Ethernet port in a first host device to receive electrical signals carrying an outbound data stream from the host device and to provide electrical signals carrying an inbound data stream to the host device. Similarly, connector 301 includes edge connector contacts 306 that fit an Ethernet port of a second host device. Connector 300 includes a first DRR device 210 to perform recovery and re-modulation of the data streams entering and exiting the cable at connector 300, and connector 301 includes a second DRR device 210 to perform recovery and re-modulation of the data streams entering and exiting the cable at connector 301.

The DRR devices 210 may be integrated circuits mounted on a printed circuit board and connected to edge connector contacts via circuit board traces. The printed circuit board in each connector may further support optical transceivers 324, 325 that convert the data streams between electrical and optical signal form for transport via optical fibers 326 in cord 314. In at least some contemplated embodiments, the printed circuit boards each also support a micro-controller unit (MCU) 328. Each DRR device 210 is coupled to a respective MCU device 328 which configures the operation of the DRR device via a two-wire bus. At power-on, the MCU device 328 loads equalization parameters from Flash memory 329 into the DRR device's configuration registers 336. The host device can access the MCU device 328 via a second two-wire bus that operates in accordance with the I2C bus protocol and/or the faster MDIO protocol. With this access to the MCU device 328, the host device can adjust the cable's operating parameters and monitor the cable's performance.

Each DRR device 210, includes a set 330 of transmitters and receivers for communicating with the host device and a set 332 of transmitters and receivers for sending and receiving via communication channels running the length of the cable. The illustrated cable supports N bidirectional communication lanes, each bidirectional lane conveyed via an optical fiber with wavelength multiplexing. The DRR devices optionally include a memory 334 to provide first-in first-out (FIFO) buffering between the transmitter & receiver sets 330, 332. An embedded controller 338 coordinates the operation of the transmitters and receivers by, e.g., setting initial equalization parameters and ensuring the training phase is complete across all lanes and links before enabling the transmitters and receiver to enter the data transfer phase. The embedded controller 338 employs a set of registers 336 to receive commands and parameter values, and to provide responses potentially including status information and performance data.

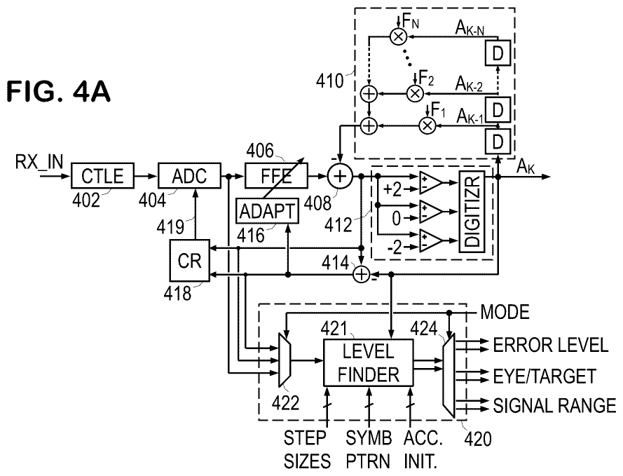

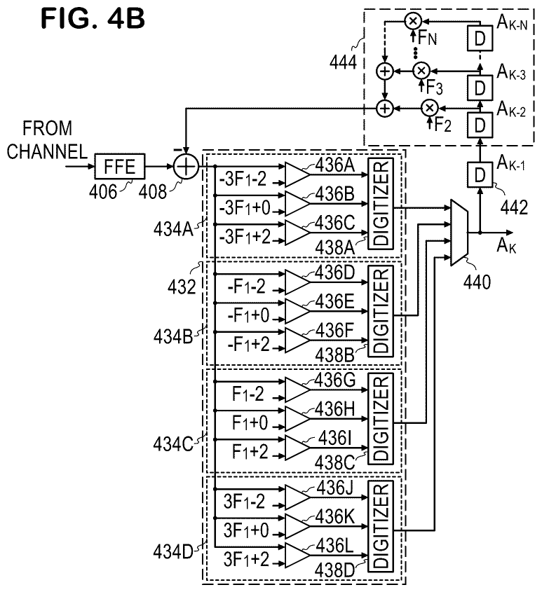

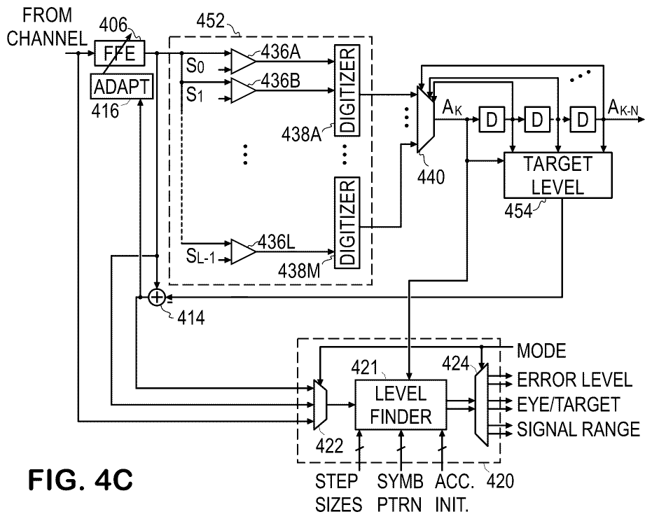

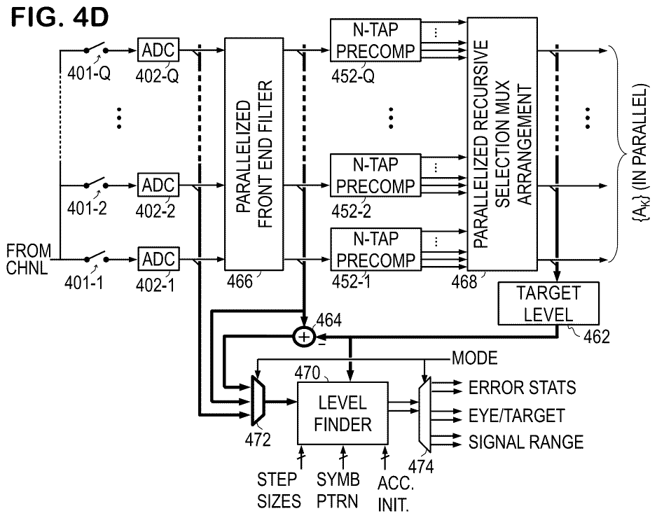

The receivers employ a suitable equalization technique such as, e.g., decision feedback equalization (DFE). FIG. 4A shows an illustrative implementation of a DFE configured for PAM4. A continuous time linear equalization (“CTLE”) filter 402 provides analog filtering to bandlimit the signal spectrum while boosting high-frequency components of the receive signal RX_IN. An analog-to-digital converter (“ADC”) 404 digitizes the filtered signal, and a digital feed-forward equalization (“FFE”) filter 406 (aka a “front end” filter) minimizes leading ISI while optionally reducing the length of the channel impulse response. A summer 408 subtracts a feedback signal, provided by feedback filter 410, from the output of the FFE filter 406 to minimize the effects of trailing ISI in the equalized signal. A decision element 412, sometimes called a “slicer”, operates on the equalized signal to determine which symbol it represents in each symbol interval. The resulting stream of symbol decisions is denoted Ak, where k is the time index.

In the illustrated example, the symbols are presumed to be PAM4 (−3, −1, +1, +3), so the comparators employed by decision element 412 use the slicer thresholds −2, 0, and +2, respectively. (The unit for expressing symbol and threshold values is omitted for generality, but for explanatory purposes may be presumed to be volts.) The comparator outputs can be taken collectively as a thermometer-coded digital representation of the output symbol decision, or a digitizer may optionally be used to convert the comparator outputs into a binary number representation, e.g., 00 to represent −3, 01 to represent −1, 10 to represent +1, and 11 to represent +3. Alternatively, a Gray-coded representation could be employed.

The DFE generates the feedback signal with a feedback filter 410 having a series of delay elements D (e.g., latches, flip flops, or shift registers) that store the recent output symbol decisions (Aₖ₋₁, Aₖ₋₂, . . . , A_{k-N}, where N is the number of filter coefficients Fᵢ). A set of multipliers determines the product of each symbol with a corresponding filter coefficient, and an array of summation elements combines the products to obtain the feedback signal.

The illustrative DFE implementation further includes an equalization error calculator 414, in this case a subtraction element that subtracts the output symbol decision Ak value from the equalized signal. The equalization error may be employed by an adaptation unit 416 and a clock recovery module 418. The adaptation unit 416 may adjust the coefficients of FFE filter 406, the coefficients of feedback filter 410. In addition, or as an alternative to adjusting the FFE filter coefficients, the adaptation unit 416 may adjust a gain control amplifier that operates on the receive signal. The adaptation unit 416 may employ any suitable adaptation technique such as those found in the open literature, which are designed to minimize the expected magnitude of the equalization error signal. The clock recovery module may also employ the equalization error alone or in combination with the symbol decisions, the equalized signal, or the receive signal, to generate a sampling clock for the ADC 404. Various suitable clock recovery techniques are disclosed in the open literature.

The illustrative implementation of FIG. 4A further includes a multi-mode level finder 420, which includes a dual level finder 421 with an input multiplexer 422 and an output demultiplexer 424. A mode selection signal MODE causes input multiplexer 422 to select one of: the unequalized signal at the input of the FFE filter 406, the equalized signal at the input of the decision element 412, and the equalization error signal calculated by summer 418. The MODE signal also causes the demultiplexer 424 to direct the detected signal levels respectively to one of: a signal range output, an eye opening/target level output, and an error level output.

Dual level finder 421 is described in detail in co-owned U.S. Pat. No. 11,018,656, issued 2021 May 25 and titled “A Multi-Function Signal Measurement Circuit for ADC-based SerDes”, which is hereby incorporated herein by reference in its entirety. The level finder's operating parameters include step sizes, symbol patterns (to indicate desired eyes and/or potentially interfering symbols), and initial accumulator settings, which can be set independently for each of the dual level finders. When the stream of output symbol decisions match the level finder's given pattern, the level finder updates its accumulator using the provided up and down step sizes. A feedback path is used to drive the accumulator contents to a level determined by the ratio of the up and down step sizes, such that the contents represent a level at which the input signal has a given probability of exceeding the level. Thus, as an example, the dual level finder 421 can determine upper and lower levels of the unequalized signal range at which the probability of the level being exceeded is, say, 2⁻¹⁰ and 1-2⁻¹⁰ (approximately 0.001 and 0.999, respectively). The signal envelope can be derived from this unequalized signal range by, e.g., taking the maximum of the upper level and the magnitude of the lower level.

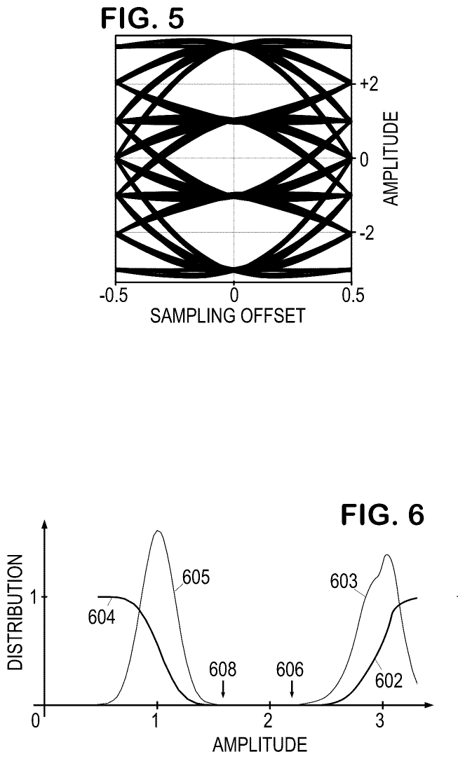

Momentarily looking ahead, FIG. 5 shows an illustrative eye diagram for a PAM4 signal at the input to decision element 412. The diagram represents a superposition of all possible signal combinations (with added noise and intersymbol interference) that may occur in the transition from a previous sampling interval to a current sampling interval. The eye diagram reveals three eyes: a first eye E₋₂ around the −2 slicer threshold, a second eye E₀ around the 0 slicer threshold, and a third eye E₂ around the +2 slicer threshold. Larger eyes provide more separation between the typical signal level and the slicer threshold, thereby enabling the system to better tolerate noise and thus providing reduced error rates.

Each eye has an upper lid and a lower lid. For example, the upper lid of eye E₂ is formed by the equalized signals representing +3 in the current symbol interval, and the lower lid is formed by the equalized signals representing +1 in the current interval. FIG. 6 is an illustrative “bathtub” plot, showing a cumulative distribution function (“CDF”) 602 for the upper lid, i.e., the probability that the equalized signal representing +3 has a value below the given amplitude. FIG. 6 also shows an approximate probability distribution function (PDF) 603 (not to scale), corresponding to the derivative of CDF 602.

For the lower lid, FIG. 6 shows a CDF 604 representing the probability that the equalized signal representing +1 has a value above the given amplitude, and an approximate PDF 605 corresponding to the magnitude of the derivative of CDF 604. While PDF 605 has an approximately normal distribution peak, PDF 603 has a skewed distribution peak attributable to optical channel nonlinearities. The level finder 421 might accordingly determine that, for a given signal probability, the upper lid of eye E₂ occurs at point 606 (shown at an amplitude of approximately 2.19) and lower lid occurs at point 608 (shown at approximately 1.59). To minimize the symbol or bit error rate, the slicer threshold should be positioned midway between the lids, i.e., 1.89 in this example rather than the +2 shown in FIG. 4A. In this fashion, the slicer thresholds for each of the eyes may be set or adapted to minimize the error rate.

In a similar fashion, the level finder 421 can use equal up/down step sizes determine the medians of each PDF 603, 605, which can serve as a “target level” used to calculate the equalization error. Such medians can be separately determined for each symbol pattern of interest, enabling channel nonlinearities to be removed from the equalization error calculation. The performance of the adaptation unit and timing recovery module improves when the equalization error is linearized in this fashion.

Returning to FIG. 4A, the dual level finder 420 accepts programmable symbol pattern selections, so that the controller for the receiver is able to iterate the level finder through the options to measure the size of each eye and the target level for each symbol pattern. The mode selection signal causes the input mux 422 to forward the slicer input signal to the dual level finder (and the demux 424 to forward the finder's adaptively determined levels to registers for storing eye opening and target level information). For the selected symbol patterns, the level finder operates to find a lower (slicer input has only a given chance of falling below) edge, an upper (slicer input has only a given chance of falling above) edge, or a median. The controller can then set the decision threshold midway between these edges to minimize error probability, and can use these target levels to linearize the equalization error calculation.

In the embodiment of FIG. 4A, the feedback filter 410 must complete its operation in less than one symbol interval because its output depends in part upon the immediately preceding decision. At very high data rates, one symbol interval does not provide sufficient time to finish the filter multiplications and the feedback subtraction. Accordingly, one solution that has been proposed in the literature is “unrolling” the feedback filter.

FIG. 4B shows an illustrative variation of FIG. 4A that unrolls the feedback filter by one tap. The embodiment of FIG. 4B employs the same front end filter 406, but summer 408 subtracts a feedback signal to remove the trailing ISI caused by all but the immediately preceding symbol. For each possible value of the immediately preceding symbol, the precompensation unit 432 provides a decision element 434A-434D. Decision element 434A speculatively assumes that the preceding symbol was −3, and rather than subtracting the ISI that would result from this symbol (−3*F1, where F₁ is the coefficient of the first tap in the original feedback filter 410), the slicer thresholds of comparators 436A-436C have been adjusted relative to the thresholds of comparators of decision element 412 by adding-3*F1, enabling decision element 434A to form a tentative symbol decision based on this speculative assumption.

Similarly, decision elements 434B, 434C, and 434D employ comparators with suitably adjusted thresholds to render tentative decisions under the speculative assumptions that the preceding symbol was −1, +1, and +3, respectively. The precompensation unit 432 supplies these tentative decisions to a multiplexer 440, which selects the proper tentative decision based on the immediately preceding symbol decision Aₖ₋₁, which is stored by delay element 442. Feedback filter 444 has a reduced number of taps (filter coefficients), but otherwise operates similarly to feedback filter 410.

Although this unrolling step increases the number of elements in the DFE loop (i.e., in the loop including summer 408, precompensation unit 432, multiplexer 230, delay element 442, and feedback filter 444), only the elements of the inner loop (i.e., the loop including multiplexer 440 and delay element 442) need to achieve their operations in less than one symbol interval. The remaining DFE loop elements can take up to two symbol intervals to complete their pipelined operation. If it is still a challenge to complete the feedback filter operation in time, further unrolling can be performed.

The disclosed principles may be extended as shown in FIG. 4C, which shows an illustrative variation in which an N-tap feedback filter has been completely unrolled. This embodiment still employs front end filter 406, but the summer 408 is eliminated since the feedback filter has been completely unrolled. Its function has been fully supplanted by precompensation unit 452, which provides a separate decision element for each combination of the N preceding symbols. The digitizers 438A-438M supply the tentative decisions to a large multiplexer 440, which selects one tentative decision from the set based on the N preceding symbol decisions held in a shift register, thereby producing the sequence of symbol decisions Ak.

Where the cardinality of the symbol set is P and the number of feedback filter coefficients is N, the number of decision elements in the precompensation unit 452 is M=P^{N}. Thus, for a PAM4 system (i.e., P=4) with a 3-tap feedback filter, the number of decision elements would be 4³=64. As each decision element employs P−1 comparators, the precompensation unit employs L=(P−1)P^{N} comparators, or 192 comparators for the 3-tap PAM4 DFE example. Thus, with each increase in the length of trailing ISI and each increase in symbol set cardinality, the size of the precompensation unit grows exponentially, as does the size of the multiplexer 440. However, the elimination of the feedback loop eliminates the associated time constraint, and the front end filter may be designed to limit the trailing ISI to a manageable size. Moreover, the various slicer thresholds Si can be independently tailored to their associated symbol patterns, enabling any channel nonlinearities to be accounted for. To linearize the equalization error calculation as discussed previously, a target level module 454 determines the target level associated with each symbol pattern, enabling the subtraction element 414 to remove channel nonlinearities. When calculating the equalization error, subtraction element 414 may need to account for a timing delay between the nonequalized signal and the corresponding target level signal.

In the DFE of FIG. 4C, only one symbol decision is output per clock cycle. At particularly high data rates, it may become necessary or desirable to apply parallelization techniques to output multiple symbol decisions per clock cycle as is done in, e.g., U.S. Pat. No. 9,071,479 (“High-speed parallel decision feedback equalizer”) and U.S. Pat. No. 9,935,800 (“Reduced complexity precompensation for decision feedback equalizer”), each of which are hereby incorporated herein by reference in their entirety. FIG. 4D shows an illustrative parallel DFE embodiment having a degree of parallelism Q. A set of sample-and-hold units 401-1 through 401-Q cyclically capture samples of the buffered analog signal in turn, each providing (in a time-staggered fashion) a stable output for up to Q clock cycles. A set of analog-to-digital converters 402-1 through 402-Q operate on the sample-and-hold outputs to obtain digitized values. A parallelized front end filter 466 combines the digitized values to provide a parallel set of slicer input values (i.e., those values that would have been sequentially produced by front end filter 406). A set of precompensation units 452-1 through 452-Q operate on the parallel set of slicer inputs to produce, in parallel, Q sets of tentative decisions. A parallelized recursive selection multiplexer arrangement 468, such as that disclosed in U.S. Pat. No. 9,071,479 (“High-speed parallel decision feedback equalizer”), operates on the Q sets of tentative decisions to produce a parallel set of Q output symbol decisions.

In this example, the dual level finder 470 operates on selected digital signals, and moreover, has been parallelized to operate on parallel sets of the selected digital signals. Target level module 462 is a similarly parallelized version of module 454. Equalization error calculator 464 represents a parallel set of subtraction elements that each subtract an output symbol decision's target level from each corresponding slicer input to provide a parallel set of error signals. The mode signal causes a parallel set of input muxes 522 to forward a parallel set of Q receive signals, a parallel set of Q slicer input signals, or a parallel set of Q error signals. The dual level finder 520 operates on the parallel set of selected signals to perform the same measurements as described previously.

Returning to the target level module 454, the target levels in the absence of any channel nonlinearities would be T(Aₖ, Aₖ₋₁, . . . , A_{k-N})=Σₙ₌₀^{N}fₙAₖ₋ₙ, with the Aₖ₋ₙ representing the symbol values −3, −1, +1, +3. The cursor coefficient f₀ is typically normalized to unity but is kept here to incorporate adaptive gain control. Limiting the present example to N=1, there would be 16 target levels. With a nonlinearity term g, these target levels become

T(Aₖ, Aₖ₋₁)=f₀Aₖ+f₁Aₖ₋₁+g(Aₖ, Aₖ₋₁). (1)

Target levels for adjacent symbol values (with their preceding symbols decisions in common) can be averaged to determine slicer thresholds.

As previously noted, the level finder can be used to determine each of these target levels that, when subtracted from the equalized signal, yield a linearized equalization error suitable for adapting filter coefficients, timing recovery, and/or gain control. To break a circular dependence between the target levels and gain control, or to otherwise limit drift in the target levels and slicer thresholds, the target levels may be “anchored” to predetermined values of the linear coefficients f₀, f₁. These predetermined values are hereafter denoted using a tilde, i.e., as \tilde{f}₀, \tilde{f}₁. Such anchoring can take the form of first determining the coefficient values representing abest linear fit to the level-finder determined target levels of equation (1). The best-fit coefficient values are hereafter denoted using a caret, i.e., as \hat{f}₀, \hat{f}₁. The controller uses the linear fit coefficients and predetermined coefficients to determine an offset for each target level, producing the anchored target levels:

\tilde{T}(Aₖ, Aₖ₋₁)=T(Aₖ, Aₖ₋₁)−[Aₖ(\hat{f}₀−\tilde{f}₀)+Aₖ₋₁(\hat{f}₁−\tilde{f}₁)] (2)

\tilde{T}(Aₖ, Aₖ₋₁)=\tilde{f}₀Aₖ+\tilde{f}₁Aₖ₋₁+g(Aₖ, Aₖ₋₁) (3)

The predetermined coefficient values may be temperature dependent to account for an expected variation in receiving channel characteristics that cause the pulse response to lose amplitude relative to its width. As the transceiver temperature increases, the receive signal envelope decreases, necessitating an adjustment of the signal gain and/or slicer thresholds to maintain a good bit error rate. To address this issue, it is herein proposed that the controller monitor the signal envelope and adjust the target levels to compensate such temperature effects. The cursor coefficient \tilde{f}₀ may be adapted based on the signal envelope, being incremented in steps while the signal envelope is less than a lower threshold and decremented in steps while the signal envelope is above an upper threshold. The preceding symbol coefficient \tilde{f}₁ may be held fixed to provide a balance between ISI cancellation capability and error propagation. These predetermined coefficient values \tilde{f}₀, \tilde{f}₁ may be compared to the best-fit coefficient values \hat{f}₀, \hat{f}₁ for the current target levels and, if they differ, the adjustment of anchoring equation (2) is applied to the current target levels. Adaptation based on the resulting equalization error will cause the signal envelope to converge within the desired range.

However, noting that the target levels are approximately \tilde{f}₀Aₖ+\tilde{f}₁Aₖ₋₁ (i.e., the nonlinearities are relatively small), a least-significant bit (LSB) increment to \tilde{f}₀ causes the target levels corresponding to the outer symbols (Aₖ=±3) to shift by three times that amount, causing a potentially significant shift in equalization error and an associated increase in the BER until the signal gain and slicer thresholds each converges to its new level. A mitigating approach that may be applied is to employ a “virtual” \tilde{f}₀ coefficient value having a higher bit resolution (or some other form of higher precision, including floating point representations) than the target levels, enabling the predetermined coefficient value to be incremented by a fraction of the target level LSB. If the \tilde{f}₀ coefficient can be incremented (and decremented) by, say, ⅓ or ¼ of the target level LSB, the outer symbol target levels will shift by no more than 1 LSB at a time. Multiple increments would occur before the inner symbol (Aₖ=±1) target levels shift, but this more gradual change enables better tracking by the adaptation technique.

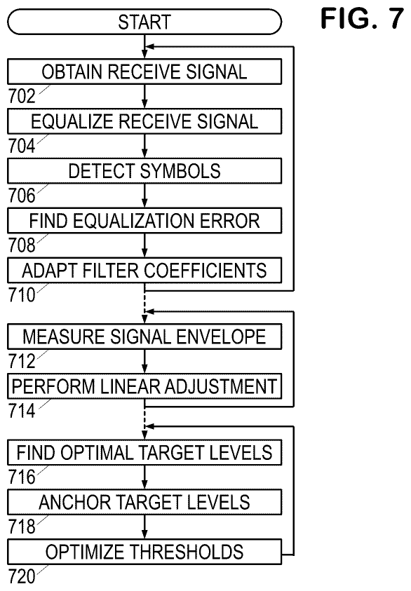

This method may be expressed in terms of a flow diagram as shown in FIG. 7. The equalizer obtains a digital receive signal in block 702. In block 704, the equalizer uses a FFE filter and optionally a feedback signal to provide an equalized signal to the decision element. In block 706, the decision element operates on the equalized signal to form symbol decisions. The equalized signal and symbol decisions are combined to calculate equalization error (or at least an error polarity signal) in block 708. In block 710, the equalizer uses the equalization error to adapt filter coefficients, adjust signal gain, and/or to derive the signal sampling clock.

In block 712, the controller uses the level finder or some other form of envelope detector to measure the signal envelope. In block 714, the controller adjusts the predetermined coefficient value as needed to drive the signal envelope into a desired range, and linearly extends the adjustment to apply corresponding offsets to each of the target levels.

In block 716, the controller uses the level finder to find optimal target levels as previously described. In block 718, these optimal levels are adjusted to anchor them to the predetermined filter coefficient values when updating the target level module. In block 720, the controller may then use the level finder to adapt the slicer thresholds as described in U.S. Pat. No. 11,018,656 (“A Multi-Function Signal Measurement Circuit for ADC-based SerDes”). Alternatively, the slicer thresholds may be derived from the optimal target levels.

For ease of explanation, the operations of FIG. 7 are shown and described as being sequential. However, it is expected that these operations will in practice be performed concurrently using pipelining or other forms of parallelism and may be distributed among various hardware components or firmware modules.

Numerous alternative forms, equivalents, and modifications will become apparent to those skilled in the art once the above disclosure is fully appreciated. For example, DFEs were used to provide context, but the disclosed principles also apply to other types of equalizers including linear equalizers, partial response equalizers, and peak detectors. Still further, the specific examples provided herein presume the use of PAM4 signaling, but the principles are readily applicable larger signal constellation sizes. It is intended that the claims be interpreted to embrace all such alternative forms, equivalents, and modifications that are encompassed in the scope of the appended claims.

What is claimed is:

1. A receiver that comprises:
an equalizer that provides an equalized signal to one or more symbol decision elements each employing multiple decision thresholds to render symbol decisions;
an equalization error calculator determining an equalization error signal by subtracting, from the equalized signal, target levels corresponding to the symbol decisions;
an adaptation module that uses the equalization error signal to adapt at least one of: a receive signal gain, a filter coefficient of the equalizer, and a sampling clock phase;
an envelope detector that measures an envelope of the equalized signal; and
a controller that determines an equalization parameter adjustment based on the envelope and determines gain-adjusted target levels by applying the equalization parameter adjustment to the target levels in proportion to their associated symbols.

2. The receiver of claim 1, wherein the target levels are determined independently to account for nonlinearities in the equalized signal.

3. The receiver of claim 1, wherein the equalization parameter adjustment has a magnitude less than an amount corresponding to a least significant bit of each target level as represented within the equalization error calculator, and wherein the controller represents each target level using a higher bit resolution than the equalization error calculator.

4. The receiver of claim 1, further comprising a level finder configurable to determine median signal levels for each symbol, wherein the controller uses the level finder to determine refined versions of the gain-adjusted target levels.

5. The receiver of claim 4, wherein the level finder further operates as the envelope detector.

6. The receiver of claim 4, wherein the equalizer is a decision feedback equalizer including:
a precompensation unit using the one or more symbol decision elements to produce tentative symbol decisions, each symbol decision element using comparators configured to compare the equalized signal to the multiple decision thresholds, the multiple decision thresholds accounting for a channel response to a set of speculative symbols including a speculative current symbol and a speculative preceding symbol, the speculative preceding symbol being different for different decision elements;
a register configured to track a preceding symbol decision of the decision feedback equalizer; and
a multiplexer configured to supply a current symbol decision selected from the tentative symbol decisions to the register based on the preceding symbol decision.

7. The receiver of claim 6, wherein the target levels used by the equalization error calculator include an independent target level for each combination of the current symbol decision and the preceding symbol decision.

8. The receiver of claim 7, wherein after determining the refined versions, the controller determines adjustments to the refined versions of the target levels to anchor the target levels to the gain-adjusted target levels.

9. A receiving method that comprises:
providing an equalized signal to one or more symbol decision elements each employing multiple decision thresholds to render symbol decisions;
determining an equalization error signal by subtracting, from the equalized signal, target levels corresponding to the symbol decisions;
using the equalization error to adapt at least one of: a receive signal gain, a filter coefficient, and a sampling clock phase;
measuring an envelope of the equalized signal; and
determining an equalization parameter adjustment based on the envelope; and
calculating gain-adjusted target levels by applying the equalization parameter adjustment to the target levels in proportion to their associated symbols.

10. The receiving method of claim 9, wherein the target levels are determined independently to account for nonlinearities in the equalized signal.

11. The receiving method of claim 9, wherein the equalization parameter adjustment has a magnitude less than an amount corresponding to a least significant bit of each target level as represented within an equalization error calculator, and wherein said calculating represents each target level using a higher bit resolution than the equalization error calculator.

12. The receiving method of claim 9, further comprising determining median signal levels for each symbol using a level finder, the median signal levels serving as refined versions of the gain-adjusted target levels.

13. The receiving method of claim 12, wherein said providing is performed by a decision feedback equalizer including:
a precompensation unit using the one or more symbol decision elements to produce tentative symbol decisions, each symbol decision element using comparators configured to compare the equalized signal to the multiple decision thresholds, the multiple decision thresholds accounting for a channel response to a set of speculative symbols including a speculative current symbol and a speculative preceding symbol, the speculative preceding symbol being different for different decision elements;
a register configured to track a preceding symbol decision of the decision feedback equalizer; and
a multiplexer configured to supply a current symbol decision selected from the tentative symbol decisions to the register based on the preceding symbol decision.

14. The receiving method of claim 13, wherein the target levels used for determining the equalization error signal include an independent target level for each combination of the current symbol decision and the preceding symbol decision.

15. The receiving method of claim 14, further comprising, after determining the refined versions, adjusting the refined versions of the target levels to anchor the target levels to the gain-adjusted target levels.

16. A nontransient information storage medium having a semiconductor intellectual property core to generate receiver circuitry comprising:
an equalizer that provides an equalized signal to one or more symbol decision elements each employing multiple decision thresholds to render symbol decisions;
an equalization error calculator determining an equalization error signal by subtracting, from the equalized signal, target levels corresponding to the symbol decisions;
an adaptation module that uses the equalization error signal to adapt at least one of: a receive signal gain, a filter coefficient of the equalizer, and a sampling clock phase;
an envelope detector that measures an envelope of the equalized signal; and
a controller that determines an equalization parameter adjustment based on the envelope and determines gain-adjusted target levels by applying the equalization parameter adjustment to the target levels in proportion to their associated symbols.

17. The nontransient information storage medium of claim 16, wherein the target levels are determined independently to account for nonlinearities in the equalized signal.

18. The nontransient information storage medium of claim 16, wherein the equalization parameter adjustment has a magnitude less than an amount corresponding to a least significant bit of each target level as represented within the equalization error calculator, and wherein the controller represents each target level using a higher bit resolution than the equalization error calculator.

19. The nontransient information storage medium of claim 16, wherein the receiver circuitry further includes a level finder configurable to determine median signal levels for each symbol, wherein the controller uses the level finder to determine refined versions of the gain-adjusted target levels.

20. The nontransient information storage medium of claim 19, wherein the equalizer is a decision feedback equalizer including:
a precompensation unit using the one or more symbol decision elements to produce tentative symbol decisions, each symbol decision element using comparators configured to compare the equalized signal to the multiple decision thresholds, the multiple decision thresholds accounting for a channel response to a set of speculative symbols including a speculative current symbol and a speculative preceding symbol, the speculative preceding symbol being different for different decision elements;
a register configured to track a preceding symbol decision of the decision feedback equalizer; and
a multiplexer configured to supply a current symbol decision selected from the tentative symbol decisions to the register based on the preceding symbol decision, and
wherein the target levels used by the equalization error calculator include an independent target level for each combination of the current symbol decision and the preceding symbol decision.
